(19) United States
(12) Patent Application Publication
(10) Pub. No.: US 2018/0365447 A1
(43) Pub. Date: Dec. 20, 2018

(54) System and Method for Signing and Authentication of Documents

(71) Applicant: Dan Rice, Los Angeles, CA (US)

(72) Inventor: Dan Rice, Los Angeles, CA (US)

(73) Assignee: bootstrap legal Inc., LOS ANGELES, CA (US)

(21) Appl. No.: 16/114,062

(22) Filed: Aug. 27, 2018

(51) Int. Cl. G06F 21/64; H04L 9/06; G06F 17/30

(52) U.S. Cl. CPC G06F 21/64; G06F 17/30097; H04L 9/0637

(57) ABSTRACT

The invention relates to a system and method for signing and authentication of documents using a distributed ledger. More specifically, the invention provides for an electronic signature system that provides increased reliability and security to authenticate signed documents using a distributed ledger.

This application hereby references and incorporates by reference U.S. patent application Ser. Nos. 16/019,270 and 16/019,203.

### FIELD OF INVENTION

The invention relates to a system and method for signing and authentication of documents using a distributed ledger. More specifically, the invention provides for an electronic signature system that provides increased reliability and security to authenticate signed documents using a distributed ledger.

### BACKGROUND OF INVENTION

Many electronic signature systems provide quick and easy way to sign documents, but fall short of providing authentication of signed documents. These systems typically provide users with a transaction receipt that identifies basic information such as date, time, email of signer, and IP address of signer. The receipt is provided as a downloadable document without further security or protective features. These simple text documents can easily be forged or altered. Some other systems provide centralized document storage wherein a copy of the signed document is stored in the system's database. Thus, a user must rely on the system provider (a third party) to authenticate the signed document. There are numerous drawbacks to exclusive reliance on a centralized third party for document storage and authentication including: unreliable standards and practices for document storage, third party could be hacked, nature of documents may be highly confidential and sensitive, third parties may be slow to respond, and third parties may not exist or go out of business.

Thus, there exists a need for a system that allows users the ability to reliably and independently verify the authenticity of a signed document without the need for a third party.

### SUMMARY OF INVENTION

The present invention is described in an embodiment implemented on a distributed ledger. However, a person of ordinary skill in the art would understand and recognize that the features of the present invention could also be used in a plurality of other systems including blockchain, directed acyclic graph (DAGs), centralized systems, and various different types of blockchains (public or private) (permissioned or permissionless) or hybrid systems.

In one embodiment, the system is implemented as a web portal that a user accesses using a computer or mobile device via web browser or mobile application. The web portal may be implemented in a central server or cloud server. The web portal communicates with a local database, document storage database, and distributed ledger. The local database is used for storage of record data. The document storage database is used to store the uploaded and signed documents. The distributed ledger is used to record the hash of the record data and hash of the documents. Lastly, the system provides a validation tool that is used to validate documents.

In one embodiment of the invention, the method of signing and recording documents proceeds as follows:

1. Portal receives a user login and password

2. Portal validates user and grants access

3. Portal receives document uploaded by user

4. Document is stored in document storage database

5. Document is hashed and recorded to distributed ledger via a merkle tree

6. Document hash combined with IP address, email authentication, and timestamp; all values are hashed to form a new hash which is recorded to distributed ledger via merkle tree

7. Portal receives at least one signature and/or text entry on document

8. Portal receives an indication from a user to finalize document

9. Signed document is hashed

10. IP addresses of signer(s), x and y coordinates of text and signatures, original document hash, hash of signed document, timestamp of finalization, and email of signer(s)

11. Portal provides user(s) with downloadable copy of final signed document and transaction receipt (records)

In one embodiment of the invention, the method of validating a document proceeds as follows:

1. Validation tool is accessed by a user via web, mobile app, API, or installed application

2. Validation tool receives transaction receipt comprising a block address on a distributed ledger and a hash value of the final signed document

3. Validation tool receives an uploaded copy of a document

4. Validation tool generates hash of document

5. Validation tool compares the generated hash with hash value from transaction receipt and/or from distributed ledger address

6. Validation tool displays result to user indicating whether the document is validated as a true and correct copy of the original

### BRIEF DESCRIPTION OF DRAWINGS

Preferred embodiments of the present invention are described with reference to the following drawing, wherein:

FIG. 1 depicts system diagram of the electronic signature and authentication system of the present invention.

### DETAILED DESCRIPTION

The present invention provides a electronic signature system using a distributed ledger. The present invention further provides validation tool that allows users to separately and independently authenticate a copy of the signed document with near absolute mathematical certainty.

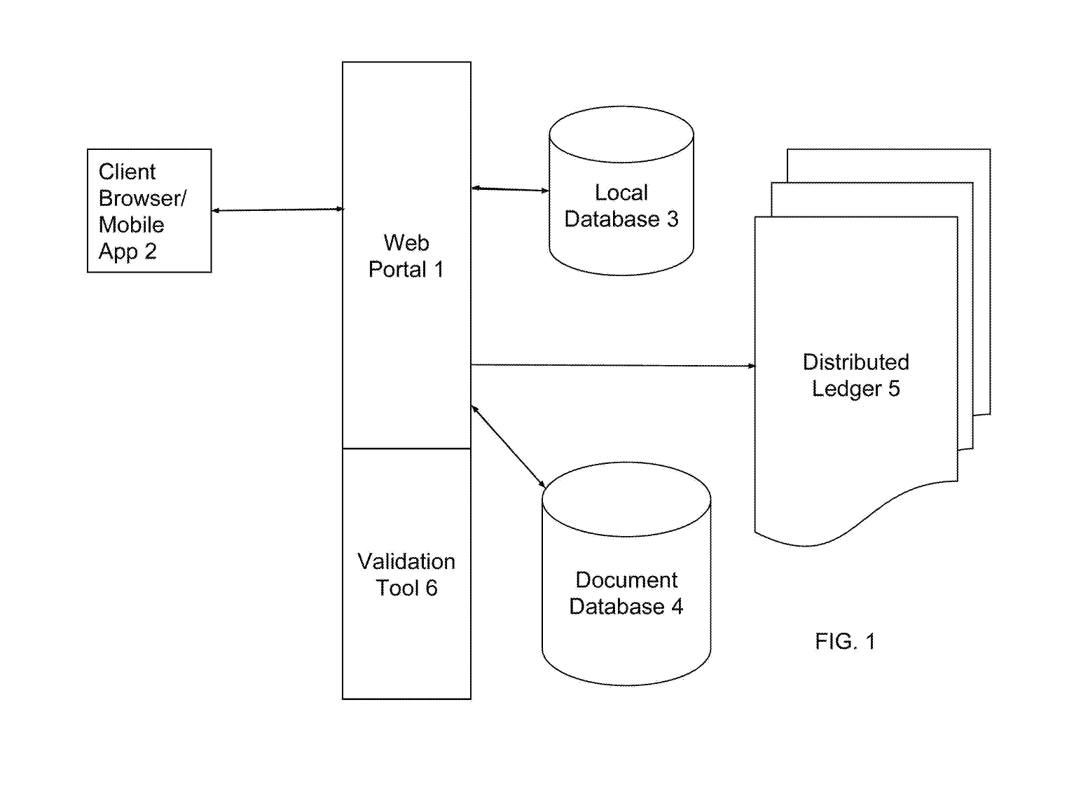

FIG. 1, depicts a system diagram of an embodiment of the system implemented as a web portal 1 that is accessible via a client browser or mobile app 2. The web portal 1 communicates with a local database 3, document storage 4, and a distributed ledger 5. The web portal 1 may be implemented in a central or cloud server. In some embodiments, the portal may be implemented as a dAPP on a blockchain or the like. The web portal 1 contains the main logic of the system and controls the electronic signature process. The web portal 1 is accessible using methods such as web browser, mobile browser, or API for a mobile application. The local database 3 may be implemented using various known methods such as a centralized database or a cloud database. The local database 3 is used to store record data generated during the electronic signature process, discussed in greater detail below. In essence, the local database 3 is used to store all record and system data except for the actual document. In some embodiments the system also uses a document storage 4 for storing documents uploaded by the user. In some embodiments the document storage 4 can also be used for long term storage and authentication where record data may also be stored with document as a client file. The distributed ledger 5 is implemented using known systems and methods, however, it should be understood that a plurality of other systems including blockchain, directed acyclic graph (DAGs), centralized systems, and various different types of blockchains (public or private) or hybrid systems could be used in its place. Lastly, the verification tool 6 may be implemented as part of the web portal 1, as a separate portal, or open source client side tool. In this particular embodiment, the verification tool 6 will be described as part of the web portal 1. The verification tool 6 allows users to validate/authenticate any document by uploading the document in question and their transaction receipt.

The method of implementing an electronic signature on a distributed ledger proceeds as follows:

1. Web portal 1 receives a user login and password
a. User login and password records are stored in the local database 3

2. Web Portal 1 validates user credentials with those stored in the local database 3 and grants access

3. Web portal 1 receives document uploaded by user

4. Document is stored in document storage 4

5. Document is hashed and the hash is recorded to distributed ledger 5 via a merkle tree

6. Document hash combined with IP address, email authentication, and timestamp; all values are collected and hashed to form a new hash which is also recorded to the distributed ledger 5 via merkle tree

7. Web portal 1 receives at least one signature and/or text entry on document
a. Web portal 1 records x and y coordinate of signature and/or text entry

8. Web portal 1 receives an indication from a user to finalize document
a. Web portal 1 generates final signed document

9. Signed document is hashed

10. IP addresses of signer(s), x and y coordinates of text and signatures, original document hash, hash of signed document, timestamp of finalization, and email of signer(s) are all packaged together and hashed
a. This list of information relating to the complete signed document comprises the transaction receipt.

11. Hash of record data is recorded to distributed ledger 5

12. Portal provides user(s) with downloadable copy of final signed document and transaction receipt (records).
a. The transaction receipt is presented to the user in a human readable format as well as digital format for download and storage; in addition to the transaction records, the transaction receipt should also include address for each record on the distributed ledger 5.

In some embodiments, the system also offers the user's an additional service of storing their documents along with transaction receipts, long term. In these embodiments, the user is provided with a login portal in which they can access their long term stored records. A login portal in accordance with an embodiment of the present invention can be found in FIG. 1, of U.S. patent application Ser. Nos. 16/019,270 and 16/019,203, the entirety of which has been incorporated by reference.

One of the major improvements of the present invention over prior systems is that it uses a distributed ledger and hash values to authenticate documents. Each record or records that have been hashed can be independently verified and authenticated with mathematical certainty. A hash serves as a fingerprint for any data. If the data is altered in any way, the hash value will be different; thus making forgery or alterations easily detectable. It is nearly impossible for two different data sets (even if they are nearly identical) to generate the same hash value. In some embodiments, the hash is implemented as SHA256 which has no known collisions. However, in other embodiments, the has can be implemented as MD5 or SHA1 which do have known collisions, but they are extremely unlikely. Thus, confirmation of data using hashes stored on a distributed ledger provides an extremely secure and accurate way of authentication and verification without having to rely on a third party.

In one embodiment of the invention, the method of validating a document proceeds as follows:

1. Validation tool 6 is accessed by a user via web, mobile app, API or installed application

2. Validation tool 6 receives transaction receipt comprising at least block address of a distributed ledger and a hash value of the final signed document

3. Validation tool 6 receives an uploaded copy of a document

4. Validation tool 6 generates hash of document

5. Validation tool 6 looks up hash value stored on distributed ledger 5

6. Validation tool 6 compares the generated hash with hash value from transaction receipt and/or from distributed ledger address

7. Validation tool 6 displays result to user indicating whether the document is validated as a true and correct copy of the original

The validation tool 6 described above relates to validating the hash of a single signed document. In some embodiments the validation tool 6 can provide users with a plurality of authentication and verification options such as authentication of original unsigned document, any record data that was hashed in step 10 of the electronic signature process above, any version of the signed/unsigned document, or the final signed document. In essence, any document of record can be validated/authenticated by generating a hash of said document or record and recording it for later use.

1. A system for electronically signing a document comprising:
a database that receives a document from a user; and
a portal that accepts an electronic signature for the uploaded document from a user, generates a hash of the electronically signed document, and records the hash to a distributed ledger.

2. The system of claim 1 further comprising:
a verification tool that:
a. receives an uploaded document to be authenticated;
b. generates a hash of the uploaded document to be authenticated;
c. compares the hash of the uploaded document to be authenticated with the hash of the electronically signed document;
d. displays whether hash values match.

3. The system of claim 1 wherein the distributed ledger system is a blockchain.

4. The system of claim 1 wherein the portal further transmits the electronically signed document and hash to the user.

5. A method for authentication of electronically signed document comprising:
a. receiving a first hash value;
b. generating a second hash value;
c. comparing first and second hash values; and
d. displaying result of comparison to a user.

6. A method of electronically signing a document comprising:
a. receiving a document from a user;
b. receiving a electronic signature from said user;
c. saving electronic signature to the received document as signed document;
d. generating a hash of signed document;
e. transmitting a copy of signed document to the user; and

7. The method of claim 6 wherein step c. further comprises:
recording record data of electronic signature including date and time of signature and name and email address of user.

8. The method of claim 7 wherein the record data further comprises the hash of the signed document.

9. The system of claim 1 wherein the portal is a web portal accessible via web browser or mobile application.

10. The system of claim 2 wherein the verification tool is a web portal accessible via web browser or mobile application

11. The system of claim 1 further comprising a local database for storing record data.

12. The system of claim 11 wherein record data includes date and time of an electronic signature.

13. The system of claim 12 wherein the record data further includes a hash value of the electronically signed document.
